(19) United States
(12) Patent Application Publication
(10) Pub. No.: US 2014/0114022 A1
(43) Pub. Date: Apr. 24, 2014

(54) CURABLE COMPOSITIONS

(71) Applicant: Marvin L. Dettloff, Lake Jackson, TX (US)

(72) Inventor: Marvin L. Dettloff, Lake Jackson, TX (US)

(73) Assignee: DOW GLOBAL TECHNOLOGIES LLC, Midland, MI (US)

(21) Appl. No.: 14/113,144

(22) PCT Filed: Apr. 20, 2012
(86) PCT No.: PCT/US12/34487

§ 371 Date: Jan. 7, 2014

Related U.S. Application Data
(60) Provisional application No. 61/479,193, filed on Apr. 26, 2011.

(51) Int. Cl. C08L 63/00

(52) U.S. Cl. CPC C08L 63/00
USPC 525/113

(57) ABSTRACT

Embodiments of the present disclosure provide a curable composition having an epoxy resin component having an epoxide equivalent weight of 75 grams/equivalent to 210 grams/equivalent, an amine component having a hydrogen equivalent weight of 18 grams/equivalent to 70 grants/equivalent, and an acrylate component having an acrylate equivalent weight of 85 grams/equivalent to 160 grams/equivalent, wherein the acrylate component is 1 part per hundred parts epoxy resin to less than 5 parts per hundred parts epoxy resin.

### CROSS-REFERENCE TO RELATED APPLICATIONS

This application claims the benefit under 35 U.S.C. §119(e) of U.S. Provisional Patent Application No. 61/479,193, filed Apr. 26, 2011, which is incorporated herein by reference in its entirety.

### FIELD OF DISCLOSURE

Embodiments of the present disclosure are directed towards curable compositions; more specifically, embodiments are directed toward curable compositions having an epoxy resin component, an amine component and an acrylate component.

### BACKGROUND

Curable compositions may include two components that can chemically react with each other to form a cured epoxy. A first component may be a resin component and a second component may be a hardening agent, sometimes called a curing agent. The resin component can include compounds, e.g. epoxy compounds that contain one or more epoxide groups. An epoxide group refers to a group in which an oxygen atom is directly attached to two adjacent carbon atoms of a carbon chain or ring system. The hardening agents include compounds that are reactive with the epoxide groups of the epoxy resins.

The resin component can be crosslinked, also referred to as curing, by the chemical reaction of the epoxide groups and the compounds of the hardening agent. This curing converts the resin component from a relatively low molecular weight into relatively high molecular weight materials by chemical addition of the compounds of the hardening agent. This crosslinking is an exothermic process that releases energy.

There are many possible uses for curable compositions and products obtained by curing those compositions. There are a great variety of characteristics that may be desirable for particular applications.

### SUMMARY

One or more embodiments of the present disclosure provide a curable composition having an epoxy resin component having an epoxide equivalent weight of 75 grams/equivalent to 210 grams/equivalent, an amine component having an amine hydrogen equivalent weight of 18 grams/equivalent to 70 grams/equivalent, and an acrylate component having an acrylate equivalent weight of 85 grams/equivalent to 160 grams/equivalent, wherein the acrylate component is from 1 part per hundred parts epoxy resin to less than 5 parts per hundred parts epoxy resin.

One or more embodiments of the present disclosure provide a method for reducing a peak exotherm of a curable composition having a theoretical maximum temperature rise of 180 degrees Celsius or greater under adiabatic conditions. The method includes selecting an epoxy resin component having an epoxide equivalent weight of 75 grams/equivalent to 210 grams/equivalent, an amine component having an amine hydrogen equivalent weight of 18 grams/equivalent to 70 grams/equivalent, and selecting an acrylate component having an acrylate equivalent weight of 85 grams/equivalent to 160 grams/equivalent, where the acrylate component is from 1 part per hundred parts epoxy resin to less than 5 parts per hundred parts epoxy resin to provide the curable composition.

The method further includes selecting a mass of the curable composition, wherein the epoxy resin component, the amine component, and the acrylate component have an equivalent ratio such that a sum of the epoxide equivalent and the acrylate equivalent divided by the amine hydrogen equivalent is from 0.9 to 1.1; verifying the theoretical adiabatic maximum temperature rise of the curable composition is 180 degrees Celsius or greater; and curing the curable composition to obtain a product.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### DETAILED DESCRIPTION

Embodiments of the present disclosure provide curable compositions. The curable compositions, as disclosed herein, includes an epoxy resin component, an amine component, and an acrylate component, wherein the acrylate component is from 1 part per hundred parts epoxy resin to less than 5 parts per hundred parts epoxy resin.

The crosslinking of epoxy resins, e.g. the curing of epoxy resins, is an exothermic process releasing energy of approximately 96 kilojoules per mole (kJ/mole) of epoxide groups. High exotherm compositions, as discussed herein, are compositions having a theoretical adiabatic maximum temperature rise of 180 degrees Celsius (° C.) or greater. For one or more embodiments, the curable compositions of the present disclosure are high exotherm compositions.

The temperatures generated by the exothermic curing of epoxy resins can result in (a) thermal degradation of one or more components of a composition that is being cured and/or (b) a defect in the final cured product. These defects can include discoloration of the final cured product, cracking, smoke generation and/or diminished fatigue resistance of the final cured part.

Surprisingly, it has been found that the curable compositions, as disclosed herein, have a reduced peak exotherm temperature compared to other compositions that do not have an acrylate component that is from 1 part per hundred parts epoxy resin to less than 5 parts per hundred parts epoxy resin. Additionally, products obtained by curing the curable compositions, as disclosed herein, have properties, such as glass transition temperature, that make those products useful for a number of particular applications.

Because the curable compositions of the present disclosure have the reduced peak exotherm temperature these compositions may be advantageously employed for applications where thermal degradation and/or a defect in the final cured product axe possible. Such applications are those that employ a relatively large mass, e.g. 100 grams or greater, of a curable composition and/or those applications that have limited heat transfer properties. Examples of these applications include, but are not limited to, electrical or electronic castings, electrical or electronic pottings, electrical or electronic encapsulations, and structural composites.

As discussed, the curable compositions of the present disclosure include an epoxy resin component, an amine component, and an acrylate component, wherein the acrylate component is from 1 part per hundred epoxy resin to less than 5 parts per hundred epoxy resin. For the various embodiments, the epoxy resin component contains uncrosslinked compounds including reactive groups, e.g. epoxide groups.

For one or more embodiments, the epoxy resin component has an epoxide equivalent weight of 75 grams/equivalent to 210 grams/equivalent. Epoxide equivalent weight may be calculated as the mass in grams of epoxy resin containing one mole of epoxide groups.

For the various embodiments, the epoxy resin component may be selected from the group consisting glycidyl ethers, glycidyl esters, glycidyl amines, divinylbenzene dioxide, and combinations thereof. Examples of glycidyl ethers include, but are not limited to: diglycidyl ethers of bisphenol A, bisphenol F and bisphenol S; glycidyl ethers of the novolaks obtainable from phenol, cresol, bisphenol A, halogenated phenols; diglycidyl ether of tetrabromo bisphenol A, diglycidyl ether of tetrabromo bisphenol S; diglycidyl ethers of resorcinol and alkylated resorcinols, diglycidyl ether of hydroquinone, diglycidyl ether of 2,5-di-tertiary butyl hydroquinone, the tetraglycidyl ether of 1,1-methylenebis(2,7-dihydroxynaphthalene), the diglycidyl ether of 4,4′-dihydroxy-3,3′,5,5′-tetramethylbiphenyl, the diglycidyl ether of 1,6-dihydroxynaphthalene, the diglycidyl ether of 9,9′-bis(4-hydroxyphenyl)fluorene, the diglycidyl ether of the reaction product of glycidol and butylated catechol, the triglycidyl ether of tris(p-hydroxyphenyl)methane, the tetraglycidyl ether of tetrakis(p-hydroxyphenyl)ethane, the monoglycidyl ether of o-cresol, diglycidyl ethers of 1,4-butanediol, 1,6-hexanediol, neopentyl glycol and dipropylene glycol, the triglycidyl ether of trimethylopropane, and combinations thereof.

Examples of glycidyl esters include, but are not limited to, diglycidyl ester of phthalic acid, diglycidyl ester of 1,2-cyclohexanedicarboxylic acid, diglycidyl ester of terephthalic acid, and combinations thereof.

Examples of glycidyl amines include, but are not limited to, diglycidylaniline, diglycidyl o-toluidine, the tetraglycidyl derivative of diaminodiphenylmetharie, tetraglycidyl derivative of 3,3′-diethyl-4,4′-diaminodiphenylmethane, the tetraglycidyl derivative of m-xylylenediamine; 1,3-bis(diglycidylaminomethyl)cyclohexane; triglycidyl-m-aminophenol, triglycidyl-p-aminophenol, and combinations thereof.

Additionally, examples of glycidyl ethers, glycidyl esters, and glycidyl amines that may be included in the curable compositions of the present disclosure may be found in Lee, H. and Neville, K., “Handbook of Epoxy Resins,” McGraw-Hill Book Company, New York, 1967, Chapter 2, pages 257-307; incorporated herein by reference. Some examples of commercially marketed glycidyl ethers, glycidyl esters, and/or glycidyl amines that may be included in the curable compositions of the present disclosure are D.E.R.™ 331, D.E.R.™ 332, D.E.R.™ 334, D.E.R.™ 580, D.E.N.™ 431, D.E.R.™ 330, D.E.R.™ 354, D.E.N.™ 438, D.E.R.™ 736, D.E.R.™ 383, and D.E.R.™ 732, each available from The Dow Chemical Company. Furthermore, examples of glycidyl ethers, glycidyl esters, and glycidyl amines that may be included in the curable compositions of the present disclosure may be found in U.S. Pat. Nos. 3,018,262; 7,163,973; 6,887,574; 6,632,893; 6,242,083; 7,037,958; 6,572,971; 6,153,719; and 5,405,688; PCT Publication WO 2006/052727; U.S. Patent Application Publication Nos. 20060293172 and 20050171237, each of which is hereby incorporated herein by reference.

For one or more embodiments, the epoxy resin component can include an epoxy compound that does not have an epoxide equivalent weight of 75 grams/equivalent to 210 grams/equivalent. However, for these embodiments the epoxy resin component as a whole will have an epoxide equivalent weight of 75 grams/equivalent to 210 grams/equivalent. For example, the epoxy resin component may include a glycidyl ether, a glycidyl ether, a glycidyl amine, divinylbenzene dioxide, or a combination thereof in addition to one or more epoxy compounds that does not have an epoxide equivalent weight of 75 grams/equivalent to 210 grams/equivalent, such that the total epoxy resin component does have an epoxide equivalent weight of 75 grams/equivalent to 210 grams/equivalent.

Examples of epoxy compounds that do not have an epoxide equivalent weight of 75 grams/ equivalent or greater include, but are not limited to, glycidol (74.1 grams/equivalent); propylene oxide (58.1 grams/equivalent); butylenes oxide (72.1 grams/equivalent); butylenes diepoxide (43.0 grams/equivalent); hexylene diepoxide (57.1 grams/equivalent); diglycidyl ether (65.1 grams/equivalent); diglycidyl thioether 73.1 grams/equivalent), and combinations thereof.

Examples of epoxy compounds that do not have an epoxide equivalent weight of 210 grams/equivalent or less include, but are not limited to, a diglycidyl ether of phenolphthalein (215.1 grams/equivalent); a glycidyl ether of a C₁₂-C₁₄ alcohol (275-300 grams/equivalent); a polypropylene glycol diglycidyl ether (310-330 grams/equivalent); a bisphenol A diglycidyl ether-bisphenol A copolymer (500-560 grams/equivalent),

As discussed, the curable compositions include an amine component. The amine component includes one or more compounds that have a N—H-(nitrogen-hydrogen) moiety.

For the various embodiments, the amine component has an amine hydrogen equivalent weight of 18 grams/equivalent to 70 grams/equivalent. Amine hydrogen equivalent weight may be calculated by dividing the mass in grams of amine component by the number of hydrogen atoms on the amine nitrogen atoms in the amine component.

For one or more embodiments, the amine component is selected from the group consisting of aliphatic polyamines, arylaliphatic polyamines, cycloaliphatic polyamines, alkanolamines, polyethelpolyamines, and combinations thereof.

Examples of aliphatic polyamines include, but are not limited to, ethylenediamine, diethylenetriamine, triethylenetetramine, trimethyl hexane diamine, hexamethylenediamine, N-(2-aminoethyl)-1,3-propanediamine, N,N′-1,2-ethanediylbis-1,3-propanediamine, dipropylenetriamine, tetraethylenepentamine, dipropylenetriamine, 2-methylpentamethylenediamine, 1,3-pentanediamine and reaction products of an excess of these amines with an epoxy resin, such as bisphenol A diglycidyl ether.

Examples of arylaliphatic polyamines include, but are not limited to, m-xylylenediamine, and p-xylylenediamine.

Examples of cycloaliphatic polyamines include, but are not limited to, 1,3-bis(aminomethyl)cyclohexane, isophorone diamine, 1,2-diaminocyclohexane, piperazine, 4,4-diaminodicyclohexylmethane, N-aminoethylpiperazine, octahydro-4,7-methano-1H-indeneditnethanamine, and 4,4′-methylenebiscyelohexaneaniine.

Examples of alkanolamines include, but are not limited to, monoethanolamine, diethanolamine, propanolamine, N-methylethanolamine, aminoethylethanolamine, and mono-hydroxyethyl diethylenetriamine.

An example of a polyetherpolyamine includes, but is not limited to, polyoxpropylene diamine, available from Huntsman International LLC as Jeffamine® D-230.

For one or more embodiments, the curable compositions may include an additional hardening agent. For embodiments including the additional hardening agent, the additional hardening agent may be used for determining the amine hydrogen equivalent weight of the amine component. However; the amine component as a whole will have an amine hydrogen equivalent weight of 18 grams/equivalent to 70 grams/equivalent, as discussed herein.

For one or more embodiments, the additional hardening agent may be selected from the group consisting of polyetherpolyamines having an amine hydrogen equivalent weight greater than 70 grams/equivalent, polyamidoamines, polyamides, aromatic amines, and combinations thereof.

Examples of polyetherpolyamines having an amine hydrogen equivalent weight greater than 70 grams/equivalent include, but are not limited to, Jeffamine ® D-400 and Jeffamine® T-403, both available from Huntsman International LLC.

An example of a polyamidoamine includes, but is not limited to, Epikure™ 3192, available from Momentive Specialty Chemicals.

Examples of polyamides include, but are not limited to, Versamid® 140, available from Cognis Chemicals Co. Ltd., and Epikure™ 3125, available from Momentive Specialty Chemicals.

Examples of aromatic amines include, but are not limited to, meta-phenylenediamine, 4,4′-diaminodiphenylmethane, 4,4′-diaminodiphenylsulfone and diethyltoluenediamine.

As discussed, the curable compositions include an acrylate component. For the various embodiments, the acrylate component includes an acrylate, e.g. a compound that contains two carbon atoms double bonded to each other and directly attached to a carbonyl carbon.

For one or more embodiments, the acrylate component has an acrylate equivalent weight of 85 grams/equivalent to 160 grams/equivalent. Acrylate equivalent weight may be calculated by dividing the molecular weight of the acrylate component by the number of acrylate moieties present in the acrylate component. For one or more embodiments, the acrylate component is limited exclusively to polyfunctional acrylates, e.g. compounds having two or more vinyl groups. Additionally, for one or more embodiments, the acrylate component excludes methacrylates, i.e. those acrylates having a methyl group attached to the alpha-carbon that is the carbon atom directly attached to the carbonyl carbon of the acrylate (those acrylates having a methyl group attached to the alpha-carbon that is the carbon atom directly attached to the carbon atom adjacent to the carbonyl carbon of the acrylate).

For one or more embodiments, the polyfunctional acrylate is selected from the group consisting of hexanediol diacrylate, tripropylene glycol diacrylate, diethylene glycol diacrylate, trimethylolpropane triacrylate, triethylene glycol diacrylate, 1,4-butanediol diacrylate, dipropylene glycol diacrylate, neopenyl glycol diacrylate, cyclohexane dimethanol diacrylate, pentaerythritol triacrylate, diptenaerythritol pentaacrylate and combinations thereof. Acrylate equivalent weight of these polyfunctional acrylates is: 113 grams/equivalent (hexanediol diacrylate), 150 grams/equivalent (tripropylene glycol diacrylate), 107 grams/equivalent (diethylene glycol diacrylate), 99 grams/equivalent (trimethylolpropane triacrylate), 129 grams/equivalent (triethylene glycol diacrylate), 99 grams/equivalent (1,4-butanediol diacrylate), 121 grams/equivalent (dipropylene glycol diacrylate), 106 grams/equivalent (neopenyl glycol diacrylate), 126 grams/equivalent (cyclohexane dimethanol diacrylate), 99 grams/equivalent (pentaerythritol triacrylate), and 105 grams/equivalent (diptenaerythritol pentaacrylate).

For the various embodiments, the acrylate component is from 1 part per hundred parts resin to less than 5 parts per hundred parts resin. For example, the acrylate component may be from 1.0 part per hundred parts resin to 4.9 parts per hundred parts resin, 1.0 part per hundred parts resin to 4.5 parts per hundred parts resin, 1.0 part per hundred parts resin to 4.0 parts per hundred parts resin, 1.0 part per hundred parts resin to 3.5 parts per hundred parts resin, or 1.0 part per hundred parts resin to 3.0 parts per hundred parts resin.

For one or more embodiments, the acrylate component may include a monofunctional acrylate and/or an acrylate having an acrylate equivalent weight that is not 85 grams/equivalent to 160 grams/equivalent. Examples of monofunctional acrylates and/or acrylates having an acrylate equivalent weight that is not 85 grams/equivalent to 160 grams/equivalent include, but are not limited to, isoctyl acrylate (184 grams/equivalent), tridecyl acrylate (255 grams/equivalent), propoxylated neopentyl glycol diacrylate (164 grams/equivalent), and combinations thereof. For embodiments including the monofunctional acrylate and/or the acrylate having an acrylate equivalent weight that is not 85 grams/equivalent to 160 grams/equivalent, the acrylate component as a whole will have an acrylate equivalent weight of 85 grams/equivalent to 160 grams/equivalent.

As discussed, the curable compositions of the present disclosure may be described as high exotherm compositions having a theoretical adiabatic maximum temperature rise of 180° C. or greater. For example, the curable compositions may have a theoretical adiabatic maximum temperature rise of 190° C. or greater, or a theoretical adiabatic maximum temperature rise of 200° C. or greater.

A theoretical adiabatic temperature rise may be determined as a quotient of a product of an amount of energy released when an epoxide group is opened (kJ/mole) and a mass of the epoxy resin component (grams) divided by the epoxide equivalent weight of the epoxy resin component (grams/equivalent) divided by a mass of the curable composition (normalized to 100 grams) divided by a heat capacity of the curable composition (kJ/g-° C.). For determining theoretical adiabatic temperature rise, the heat capacity of the curable compositions has a value of 0.002 kJ/g-° C. This heat capacity value was derived with data from the Chemical Properties Handbook [Ed.: Yaw, C. L.; McGraw-Hill, 1999; electronic ISBN: 978-1-59124-028-0], as accessed at www.knovel.com on Mar. 30, 2011. As discussed, the amount of energy released when an epoxide group is opened is 96 kJ/mole.

As discussed, the curable compositions of the present disclosure include the epoxy resin component, the amine component, and the acrylate component. For one or more embodiments, the epoxy resin component, the amine component, and the acrylate component are included in the curable composition such that a sum of epoxide equivalents and acrylate equivalents divided by the amine hydrogen equivalents is from 0.9 to 1.1. For example, the sum of the epoxide equivalents and the acrylate equivalents divided by the amine hydrogen equivalents may be 0.9, 0.099, 0.99, 1.0, 1.05, or 1.1. As used herein “epoxide equivalent” refers to a number of epoxide groups in a curable composition having a particular mass of the epoxy resin component. As used herein “acrylate equivalent” refers to a number of acrylate groups in a curable composition having a particular mass of the acrylate component. As used herein “acrylate equivalent” refers to a number hydrogen atoms on the amine nitrogen atoms in the amine component in a curable composition having a particular mass of the amine component. As used herein “amine hydrogen equivalent” refers to the number of hydrogen atoms on the amine nitrogen atoms in the amine component in a curable composition having a particular mass of the amine component.

This relationship between the epoxy resin component, the amine component, and the acrylate component may help to provide the reduced peak exotherm, as compared to other compositions that do not have this relationship. Additionally, this relationship may help provide that products obtained by curing the curable compositions have properties, such as glass transition temperature, that make those products useful for particular applications.

For one or more embodiments, the curable compositions may include an additive. Examples of additives include, but are not limited to, nonreactive and reactive diluents; catalysts; other curing agents; other resins; fibers; fillers such as wollastonite, barites, mica, feldspar, talc, silica, crystalline silica, fused silica, fumed silica, glass, metal powders, carbon nanotubes, graphene, and calcium carbonate; aggregates such as glass beads, polytetrafluoroethylene, polyol resins, polyester resins, phenolic resins, graphite, molybdenum disulfide and abrasive pigments; viscosity reducing agents; boron nitride; nucleating agents; dyes; pigments such as titanium dioxide, carbon black, iron oxides, chrome oxide, and organic pigments; coloring agents; thixotropic agents, photo initiators; latent photo initiators, latent catalysts; inhibitors; flow modifiers; accelerators; desiccating additives; surfactants; adhesion promoters; fluidity control agents; stabilizers; ion scavengers; UV stabilizers; flexibilizers; fire retardants; diluents that aid processing; toughening agents; wetting agents; mold release agents; coupling agents; tackifying agents, and combinations thereof.

The curable compositions of the present disclosure may be cured to obtain a product. For one or more embodiments the curable composition can be cured at a cure temperature in a range with a lower limit of 0 degrees ° C., 10° C., or 15° C. to an upper limit of 80° C., 85° C., or 90° C. where a range having combinations of the lower limit and upper limit are possible. For example, the curable composition can be cured at a temperature in a range of 0° C. to 90° C.; 10° C. to 85° C.; or 15° C. to 80° C. For one or more embodiments, the curable compositions of the present disclosure can be cured to obtain the product for a time interval with a lower limit of 1 hour, 2 hours, or 3 hours to an upper limit of 48 hours, 36 hours, or 24 hours. For example, the curable composition can be cured to obtain a product for a time interval of 1 hour to 48 hours; 2 hours to 36 hours; or 3 hours to 24 hours. A post-cure can also be used, where temperatures for the post-cure can reach 200° C. for several hours.

As discussed, products obtained by curing the curable compositions of the present disclosure have properties, such as glass transition temperature, that make those products useful for a number of particular applications. Examples of these applications include, but are not limited to, electrical or electronic castings, electrical or electronic pottings, electrical or electronic encapsulations, and structural composites.

Glass transition temperature can be described as a temperature, or a temperature range, where mechanical properties of a material change. Below a material's glass transition temperature that material will behave as a brittle solid (e.g., a glass solid). Above the material's glass transition temperature the material will behave as a ductile solid or as a viscous liquid. For some applications, such as those discussed herein, it may be desirable for products that are obtained by curing the curable compositions to have a relatively high glass transition temperature. A relatively high glass transition can be considered to be a glass transition temperature of a product obtained by curing a curable composition of the present disclosure that is reduced by 15 percent or less as compared to a glass transition temperature of another product obtained by curing a second curable composition (that is the second curable composition that does not contain the acrylate). The product obtained by curing a curable composition of the present disclosure and the other product obtained by curing a second curable composition include a like concentration, e.g. within 2 weight percent, of the epoxy resin component and the amine component, respectively.

As discussed, one or more embodiments of the present disclosure provide a method for reducing a peak exotherm of a curable composition having a theoretical maximum temperature rise of 180° C. or greater under adiabatic conditions. The method may include selecting an epoxy resin component, as discussed herein, having an epoxide equivalent weight of 75 grams/equivalent to 210 grams/equivalent. The method may include selecting an amine component, as discussed herein, having a hydrogen equivalent weight of 18 grams/equivalent to 70 grams/equivalent. The method may.include selecting an acrylate component, as discussed herein, having an acrylate equivalent weight of 85 grams/equivalent to 160 grams/equivalent, where the acrylate component is from 1 part per hundred parts epoxy resin to less than 5 parts per hundred parts epoxy resin.

The method may further include selecting a mass of the curable composition, wherein the epoxy resin component, the amine component, and the acrylate component have an equivalent ratio such that a sum of the epoxide equivalent and the acrylate equivalent divided by the hydrogen equivalent is from 0.9 to 1.1. Additionally, the method may include verifying the theoretical adiabatic maximum temperature rise of the curable composition is 180 degrees ° C. or greater. Verifying the theoretical adiabatic maximum temperature rise of the curable composition is 180 degrees ° C. or greater may include determining the theoretical maximum temperature rise under adiabatic conditions as a quotient of a product of an amount of energy released when an epoxide group is opened (kJ/mole) and a mass of the epoxy resin component (grams) divided by the epoxide equivalent weight of the epoxy resin component (grams/equivalent) divided by a mass of the curable composition based upon 100 parts of the epoxy resin component (grams) divided by a heat capacity of the curable composition (kJ/g-° C.). The method may further include curing the curable composition to obtain a product, as discussed herein.

### EXAMPLES

In the Examples, various terms and designations for materials were used including, for example, the following:

D.E.R.™ 383 (glycidyl ether (diglycidyl ether of bisphenol A), epoxide equivalent weight 180.7 grams/equivalent), available from The Dow Chemical Company.

1,4-butanedioldiglycidyl ether (glycidyl ether, epoxide equivalent weight 130.0 grams/equivalent), available from The Dow Chemical Company.

Vestamin® IPD (cycloaliphatic polyamine (isophorone diamine), amine hydrogen equivalent weight 42.5 grams/equivalent), available from Evonik.

Jeffamine® D-230 (polyetherpolyamine (polyoxpropylene diamine), amine hydrogen equivalent weight 60.0 grams/equivalent), available from Huntsman International LLC.

Trimethylolpropane triacrylate (polyfunctional acrylate, acrylate equivalent weight 99 grams/equivalent), available from Aldrich Chemical.

### Example 1

### Curable Composition

Example 1, a curable composition, was prepared as follows. An epoxy resin component including D.E.R.™ 383 (81 grams) and 1,4-butanedioldiglycidyl ether (15 grams) was combined with an acrylate component including trimethylolpropane triacrylate (4 grams) to form a mixture of the epoxy resin component and the acrylate component. An amine component was prepared by combining Jeffamine® D-230 (64 grams) and Vestamin® IPD (36 grams). The mixture (76 grams) of the epoxy resin component and the acrylate component was combined with the amine component (24 grams) to provide Example 1. Example 1 included 61.6 grams of the diglycidyl ether of bisphenol A, 11.4 grams of 1,4-butanedioldiglycidyl ether, 3.0 grams of trimethylolpropane triacrylate (4.17 parts per hundred parts epoxy, resin), 15.4 grams of polyoxpropylene diamine, and 8.6 grams of isophorone diamine.

The theoretical adiabatic maximum temperature rise for Example 1 was determined by the following calculation: (96 kJ/mole)*(73 grams)/(170.3 grams/equivalent)/(100 grams)/(0.002 kJ/gram-° C.)=205.8° C., where 170.3 grams/equivalent was the epoxide equivalent weight of the epoxy resin component. The theoretical adiabatic maximum temperature rise of 205.8° C. indicates that Example 1 is a high exotherm composition.

Example 1's epoxide equivalent was 0.429 (0.341 epoxide equivalents from the D.E.R.™ 383 plus 0.088 epoxide equivalents from the 1,4-butanedioldiglycidyl ether), Example 1's acrylate equivalent was 0.030, and Example 1's amine hydrogen equivalent was 0.459. Example 1 included these components such that (0.429 equivalents+0.030 equivalents)/0.459 equivalents=1.0

### Example 2

### A Curable Composition

Example 2, a curable composition, was prepared as follows. An epoxy resin component including D.E.R.™ 383 (83 grams) and 1,4-butanedioldiglycidyl ether (15 grams) was combined with an acrylate component including trimethylolpropane triacrylate (2 grams) to form a mixture of the epoxy resin component and the acrylate component. An amine component was prepared by combining Jeffamine® D-230 (64 grams) and Vestarnin® IPD (36 grams). The mixture (76.3 grams) of the epoxy resin component and the acrylate component was combined with the amine component (23.7 grams) to provide Example 2. Example 2 included 63.3 grams of diglycidyl ether of bisphenol A, 11.5 grams of 1, 4-butanedioldiglycidyl ether, 1.5 grams of trimethylolpropane triacrylate (2.04 parts per hundred parts epoxy resin), 15.2 grams of polyoxpropylene diamine, and 8.5 grams of isophorone diamine.

The theoretical adiabatic maximum temperature rise for Example 2 was determined by the following calculation: (96 kJ/mole)*(74.8 grams)/(170.5 grams/equivalent)/(100 grams)/(0.002 kJ/gram-° C.)=210.6° C., where 170.5 grams/equivalent was the epoxide equivalent weight of the epoxy resin component. The theoretical adiabatic maximum temperature rise of 210.6° C. indicates that Example 2 is a high exotherm composition.

Example 2's epoxide equivalent was 0.439 (summed as for Example 1), Example 2's acrylate equivalent was 0.020, and Example 2's amine hydrogen equivalent was 0.453. Example 2 included these components such that (0.438 equivalents+0.020 equivalents)/0.453 equivalents=1.01.

### Comparative Example A, Curable Composition

Comparative Example A, a curable composition, was prepared as follows. An epoxy resin component was prepared by combining D.E.R.™ 383 (85 grams) and 1,4-butanedioldiglycidyl ether (15 grams). An amine component was prepared by combining Jeffamine® D-230 (64 grams) and isophorone diamine (36 grams). The epoxy resin component (76.5 grams) was combined with the amine component (23.5 grams) to provide Comparative Example A. Comparative Example A included 65.0 grams of the diglycidyl ether of bisphenol A, 11.5 grams of 1,4-butanedioldiglycidyl ether, 15.0 grams polyoxpropylene diamine, and 8.5 grams of isophorone diamine.

Theoretical adiabatic maximum temperature rise for Comparative Example A was determined by the following calculation: (96 kJ/mole)*(76.5 grams)/(170.6 grams/equivalent)/(100 grams)/(0.002 kJ/gram/° C.)=215.2° C. The theoretical adiabatic maximum temperature rise of 215.2° C. indicates that Comparative Example A is a high exotherm composition.

### Nonadiabatic Peak Exotherm Temperature

Nonadiabatic peak exotherm temperature for a 100 gram sample of Example 1 was determined as follows. Example 1's mixture of the epoxy resin component (61.6 grams of the diglycidyl ether of bisphenol A, 11.4 grams of 1,4-butanedioldiglycidyl ether) and the acrylate component (3.0 grams of trimethylolpropane triacrylate) was heated to 23° C. Example 1's amine component (15.4 grams of polyoxpropylene diamine, 8.6 grams of isophorone diamine) was heated to 23° C. The heated mixture and amine component were mixed in a paper cup. A Teflon® coated thermocouple was inserted into the center of the cup contents and the temperature was recorded for 14 hours. Nonadiabatic peak exotherm temperature for a 100 gram sample of Example 2 was determined as Example 1 with the change: Example 2 epoxy resin component (63.3 grams of diglycidyl ether of bisphenol A, 11.5 grams of 1,4-butanedioldiglycidyl ether), Example 2 acrylate component (1.5 grams of trimethylolpropane triacrylate), Example 2 amine component (15.2 grams of polyoxpropylene diamine, 8.5 grams of isophorone diamine). Nonadiabatic peak exotherm temperature for a 100 gram sample of Comparative Example A was determined as Example 1 with the change: Comparative Example A epoxy resin component (65.0 grams of the diglycidyl ether of bisphenol A, 11.5 grams of 1,4-butanedioldiglycidyl ether), Comparative Example A amine component (15.0 grams of polyoxpropylene diamine, 8.5 grams of isophorone diamine).

Table I shows the nonadiabatic peak exotherm temperatures for Example 1, Example 2, and Comparative Example A.

TABLE I

| | Nonadiabatic Peak |
|---|---|
| Curable Composition | Exotherm Temperature (° C.) |
| Example 1 | 38.3 |
| Example 2 | 43.6 |
| Comparative Example A | 64.0 |

The results shown in Table I demonstrate that Example 1, which included 4.17 parts per hundred parts resin of the acrylate component, had a lower peak exotherm temperature as compared to Comparative Example A, which did not include the acrylate component. Example 1's 4.17 parts per hundred parts resin of the acrylate component helped to provide an approximately 40 percent reduction in the nonadiabatic peak exotherm temperature.

The results shown in Table I demonstrate that Example 2, which included 2.04 parts per hundred parts resin of the acrylate component, had a lower peak exotherm temperature as compared to Comparative Example A, which did not include the acrylate component. Example 2's 2.04 parts per hundred parts resin of the acrylate component helped to provide an approximately 32 percent reduction in the nonadiabatic peak exotherm temperature.

It is noted that nonadiabatic peak exotherm temperatures were determined to mitigate safety concerns associated with experimental adiabatic conditions. The nonadiatatic peak exotherm temperatures were expectedly lower than the theoretical adiabatic maximum temperature rise. However, the nonadiatatic peak exotherm temperatures serve to illustrate the effectiveness of the acrylate component, as disclosed herein.

### Example 3

### Product Obtained by Curing Example 1

Example 3, a product obtained by curing Example 1, was prepared as follows. Ten grams of Example 1 was placed into an aluminum pan. The contents of the aluminum pan were heated to 70° C. and maintained at that temperature for 7 hours to provide Example 3.

### Example 4

### Product Obtained by Curing Example 2

Example 4, a product obtained by curing Example 2, was prepared as follows. Ten grams of Example 2 was placed into an aluminum pan. The contents of the aluminum pan were heated to 70° C. and maintained at that temperature for 7 hours to provide Example 4.

### Comparative Example B, Product Obtained by Curing Comparative Example A

Comparative Example B, a product obtained by curing Comparative Example A, was prepared as Example 3, with the change: Comparative Example A replaced Example 1.

Glass transition temperature for Example 3 was determined as follows. A 10 milligram sample of Example 3 was placed in a TA Instruments Q100 Differential Scanning calorimeter. A dynamic temperature scan from 35° C. to 200° C. was applied with a 10° C. per minute heating rate and a nitrogen purge. Glass transition temperature for Example 4 was determined as Example 3 with the change: Example 3 was replaced with Example 4. Glass transition temperature for Comparative Example B was determined as Example 3 with the change: Comparative Example B replaced Example 3.

Table II shows the glass transition temperatures for Example 3, Example 4, and Comparative Example B.

TABLE II

| | Glass Transition |
|---|---|
| Product | Temperature (° C.) |
| Example 3 | 72 |
| Example 4 | 75 |
| Comparative Example B | 78 |

The results shown in Table II demonstrate that Example 3, which was obtained by curing a curable composition that contained 4.17 parts per hundred parts resin of the acrylate component, had a glass transition temperature that was reduced by approximately 7.7 percent, as compared to Comparative Example A, which did not include the acrylate component

The results shown in Table II demonstrate that Example 4, which was obtained by curing a curable composition that contained 2.04 parts per hundred parts resin of the acrylate component, had a glass transition temperature that was reduced by approximately 3.8 percent, as compared to Comparative Example A, which did not include the acrylate component.

While Example 3 and Example 4 each had a lower glass transition temperature than Comparative Example B, those lower glass transition temperatures are comparable, e.g. reduced by 15 percent or less as compared to an acrylate free composition. These comparable glass transition temperatures serve to illustrate that Example 3 and Example 4 are suitable for particular applications, as discussed herein.

1. A curable composition comprising:
an epoxy resin component having an epoxide equivalent weight of 75 grams/equivalent to 210 grams/equivalent;
an amine component having a hydrogen equivalent weight of 18 grams/equivalent to 70 grams/equivalent; and
an acrylate component having an acrylate equivalent weight of 85 grams/equivalent to 160 grams/equivalent, wherein the acrylate component is from 1 part per hundred parts epoxy resin to less than 5 parts per hundred parts epoxy resin.

2. The composition of claim 1, wherein the epoxy resin component includes an epoxide selected from the group consisting of glycidyl ethers, glycidyl esters, glycidyl amines, divinylbenzene dioxide, and combinations thereof.

3. The composition of claim 1, wherein the amine component is selected from the group consisting of aliphatic polyamines, arylaliphatic polyamines, cycloaliphatic polyamines, alkanolamines, polyetherpolyamines, and combinations thereof.

4. The composition of claim 1, wherein the acrylate component consists of a plurality of acrylate compounds and each of the plurality acrylate compounds includes two or more acrylate groups.

5. The composition of claim 1, wherein the epoxy resin component, the amine component, and the acrylate component are included such that a sum of the epoxide equivalent weight and the acrylate equivalent weight divided by the hydrogen equivalent weight is from 0.9 to 1.1.

6. The composition of claim 1, wherein the epoxy resin component epoxide equivalent weight is 165 grams/equivalent to 175 grams/equivalent; the amine component hydrogen equivalent weight is 50 grams/equivalent to 55 grams/equivalent, the acrylate component acrylate equivalent weight is 95 grams/equivalent to 105 grams/equivalent.

7. A product obtained by curing the curable composition of claim 1.

8. A method for reducing a peak exotherm of a curable composition having a theoretical maximum temperature rise of 180 degrees Celsius or greater under adiabatic conditions, the method comprising:
selecting an epoxy resin component having an epoxide equivalent weight of 75 grams/equivalent to 210 grams/equivalent, an amine component having a hydrogen equivalent weight of 18 grams/equivalent to 70 grams/equivalent, and selecting an acrylate component having an acrylate equivalent weight of 85 grams/equivalent to 160 grams/equivalent, where the acrylate component is from 1 part per hundred parts epoxy resin to less than 5 parts per hundred parts epoxy resin to provide the curable composition;
selecting a mass of the curable composition, wherein the epoxy resin component, the amine component, and the acrylate component have an equivalent ratio such that a sum of the epoxide equivalent weight and the acrylate equivalent weight divided by the hydrogen equivalent weight is from 0.9 to 1.1;
verifying the theoretical adiabatic maximum temperature rise of the curable composition is 180 degrees Celsius or greater; and
curing the curable composition to obtain a product.

9. The method of claim 8, wherein verifying the theoretical adiabatic maximum temperature rise includes determining the theoretical maximum temperature rise under adiabatic conditions as a quotient of a product of an amount of energy released when an epoxide group is opened (kJ/mole) and a mass of the epoxy resin component (grains) divided by the epoxide equivalent weight of the epoxy resin component (grams/equivalent) divided by a mass of the curable composition based upon 100 parts of the epoxy resin component (grams) divided by a heat capacity of the curable composition (kJ/g-° C.).

10. The method of claim 8, including: selecting a mass of the acrylate component such that the product has a glass transition temperature that is reduced by 15 percent or less as compared to a product obtained by curing an acrylate free composition, where the acrylate free composition has a like concentration of the epoxy resin component and the amine component.
